(19) United States
(12) Patent Application Publication
(10) Pub. No.: US 2007/0260591 A1
(43) Pub. Date: Nov. 8, 2007

(54) SYSTEM AND METHOD OF PROVIDING INTEGRATED CALENDARING AND CONCIERGE SERVICES

(76) Inventors: Michele Ellie Ahi, San Jose, CA (US); Michael M. Ahi, San Jose, CA (US)

Correspondence Address: WEST & ASSOCIATES, A PC, 2815 MITCHELL DRIVE, SUITE 209, WALNUT CREEK, CA, 94598, US

(21) Appl. No.: 11/742,538

(22) Filed: Apr. 30, 2007

Related U.S. Application Data
(60) Provisional application No. 60/795,486, filed on Apr. 28, 2006.
(60) Provisional application No. 60/795,471, filed on Apr. 28, 2006.

(51) Int. Cl. G06F 17/30

(52) U.S. Cl. 707/3

(57) ABSTRACT

A system and method of providing integrated calendaring and concierge services comprising, receiving user data, receiving vendor data, matching user data with vendor data and reporting said matched user data and vendor data, wherein searching and indexing can be conducted based upon any one or number of predetermined factors including geographic location and availability of a desired good and/or service.

### CLAIM OF PRIORITY

This application claims priority to U.S. Provisional Patent application No. 60/795,486, filed Apr. 28, 2006 and U.S. Provisional Patent application No. 60/795,471, filed Apr. 28, 2006.

### BACKGROUND

1. Field of the Invention

The disclosure relates in general to calendaring and orderings systems and method and more specifically to integrated calendaring and at least partially automated concierge services.

2. Background

Modernly, people in the work force rely heavily upon electronic calendaring systems, to-do list and the internet to keep track of their busy schedules and to keep up to date with current events and trends. Additionally, most individuals and businesses regularly use the internet to book plane tickets, make dinner reservations and make general purchases of goods and services.

Numerous companies have websites that can assist the user in placing their orders and/or obtaining a good/the best price for a particular item. However, none of these systems are directly linked to a consumer's calendar or are adapted to select items based on a user's set of pre-selected preferences and/or intended user/recipient data which is contained outside the host-site's system. Thus, when a user wants to make a purchase, arrange a plane ticket, make a dinner reservation, etc. the user must leave the user's calendar and actively enter the site providing the desired goods/services.

What is needed is a system that can integrate with a user's calendar and with a user's set of preferences contained on the user's system and can in at least a partially automated manner make desired purchases, reservations, etc. based on the events contained in the user's calendar or to-do list and the user's set of preferences contained within the user's system.

### SUMMARY

A system and method of providing integrated calendaring and concierge services comprising, receiving user data, receiving vendor data, matching user data with vendor data and reporting said matched user data and vendor data. In some embodiments, searching and indexing can be conducted based upon any one or number of predetermined factors including geographic location and availability of a desired item or service.

### BRIEF DESCRIPTION OF THE DRAWINGS

FIG. 1 depicts a schematic of the system.

FIG. 2 depicts a schematic of a vendor interaction with the system of FIG. 1.

FIG. 3 depicts a user interaction with the system of FIG. 1

FIG. 4 depicts a alternate schematic of the system depicted in FIG. 1

FIG. 5 depicts a flow chart of the operation of a calendaring

FIG. 6 depicts an embodiment of a calendaring system.

FIG. 7 depicts an embodiment of a calendaring system.

FIG. 8 depicts a flow chart of a categorized search method

FIG. 9 depicts a flow chart of a filtered search method

FIG. 10 depict a method of geographically categorizing web pages.

FIG. 11 depicts a flow chart of a inventory search based on predetermined data.

FIG. 12 depicts a flow chart of automated ordering based on predetermined data.

FIG. 13 depicts a flow chart of a computer network capable of implementing the described methods.

### DETAILED DESCRIPTION

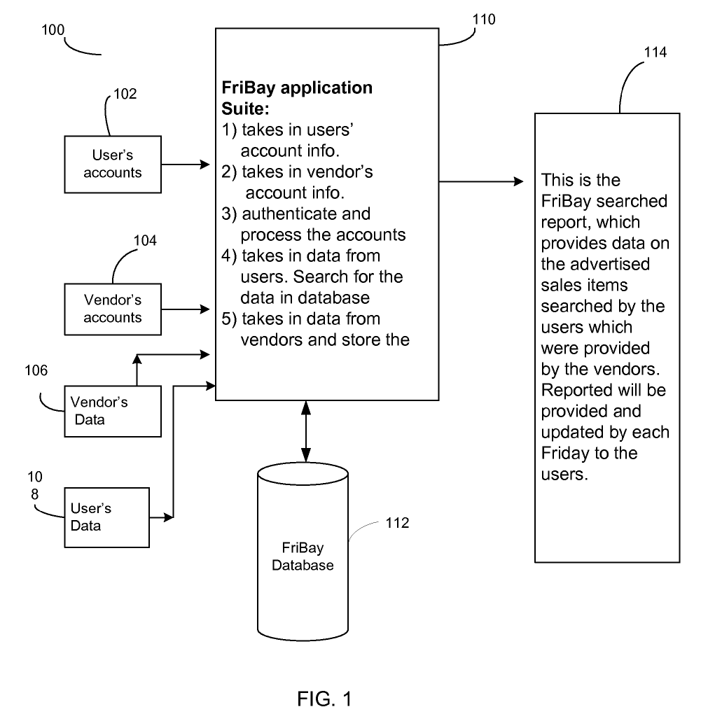

FIG. 1 depicts one embodiment of a high level schematic of an integrated calendaring and concierge service 100. The embodiment shown in FIG. 1 is comprised of a user account module 102, a vendor account module 104, a vendor data module 106 and a user account module 108. In the embodiment shown in FIG. 1, the data collected from the modules 102-108 can be delivered to an application suite 110. The application suite 110 can then interact with a database 112 and produce a report 114.

In the embodiment depicted in FIG. 1, the user account module 102 can include registration information and data of any type and/or kind desired. In some embodiments the user account module can include name, address, gender, marital status, familial information, display preferences, user name, password, account type and/or any other known and/or convenient information. Similarly, the vendor account module 104 can include registration information and data of any type and/or kind desired. In some embodiments the vendor account module can include name, address(es), display preferences, vendor size, number of locations, user name, password and/or any other known and/or convenient information.

In the embodiment depicted in FIG. 1, the vendor data 106 module can include any known and/or convenient data related to the vendor's account and any known and/or convenient data regarding the vendor's items and/or services for sale, such as item name, available quantities, available sizes and quantities available of given sizes, shipping times, local availability at various vendor locations, Universal Product Code (UPC) information, product and/or service description and/or images, Stock Keeping Unit(s) (SKU) information, pricing information, item number information, promotional and/or event information and/or any other know and/or convenient data related to the vendor's inventory of goods and/or services. In some embodiments this information can be entered directly into the system 100. However, in alternate embodiments the data can be retrieved from existing data stored on another system via any known and/or convenient transfer protocol and/or mechanism. In some embodiments, the data can be transferred and/or synchronized via “push” technology and/or periodic synchronization with a vendor's database. Additionally, in some embodiments, the system can prompt a vendor to input data and/or the desired data can be obtained from the vendor's database on an as-needed basis via any know and/or convenient system and/or method.

In some embodiments, the user data module 108 can contain information any known and/or convenient data related to the users account and any known and/or convenient data regarding the user's preferences, such as size information for the user and/or any other person and/or entity, various shipping/delivery addresses for the user and/or any other person and/or entity, preferred stores and/or service providers, seating preferences, event preferences, cuisine preferences, calendar/schedule information, special event information related to the user and/or any other desired person and/or entity, to-do listings for the user and/or any other person and/or entity, travel information related to the user and/or any other person and/or entity, and/or preference information regarding and/or any other known and/or convenient data related to the user and/or any third party. In some embodiments this information can be entered directly into the system 100. However, in alternate embodiments the data can be retrieved from existing data stored on another system via any known and/or convenient transfer protocol and/or mechanism. In some embodiments, the data can be transferred and/or synchronized via “push” technology and/or periodic synchronization with a user's handled device and/or other personal data management system. Additionally, in some embodiments, the system can prompt a user to input data and/or can allow free-form entry of data which can later be parsed.

In the embodiment depicted in FIG. 1, the application suite 110 can receive all and/or selected portions of the user account module 102 data, vendor account module 104 data, vendor data 106 data and user data 108 and perform searching, cross-referencing and indexing functions to determine of the received data and searching, cross-referencing and indexing functions on a secondary database 112 to determine matches between user account module 104 data, user data 108 and vendor account module 104 and vendor data 106. In some embodiments, the user account module 102 data, vendor account module 104 data, vendor data 106 data and user data 108 can be stored on the secondary database 112 and/or can be referenced on the secondary database 112.

In some embodiments, the system 100 can produce a report 114 to a user and/or a vendor regarding a match. In some embodiments, the report can be produced periodically according to vendor, user and/or any predetermined schedule and/or can be produced on an as-available basis.

In operation, a user may have a defined event in a user's calendar such as “Wife's Birthday.” The user data may contain various size and/or gift and/or vendor/designer preferences for the user's wife—for example, Dress Size: 4, preferred vendor: Banana Republic, favorite color: Light Grey. The system can then index, cross-reference and search this information relative to the various Vendor's data and obtain a match for a local Banana Republic store, carrying a size 4 dress in light grey. The system could then return the information to the user or present the user with a link to either the website and/or contact information for the local store. In some embodiments, the system 100 could directly interact with the vendor either manually or via electronic communication and purchase the item from the local store or place the item “on hold” for the user or purchase the item from a website (using the user's banking and/or credit card information) and have the item directly shipped to the user and/or the user's wife. The system can also be used to arrange for purchase, availability, delivery, viewing and/or booking for any other goods and/or services offered by any vendor.

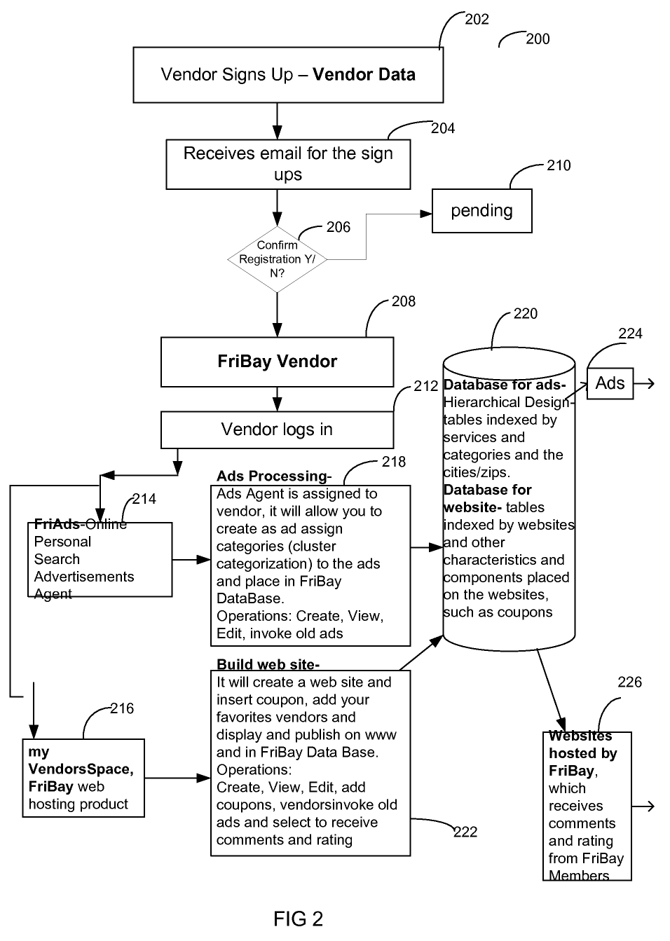

FIG. 2, depicts an embodiment of a vendor access point 200. In the embodiment depicted in FIG. 2, a vendor can provide vendor data 202 which can be conveyed to the system 100. The system 100 can then generate a confirmation 204 in the form of an e-mail or any other know and/or convenient form. In step 206, the vendor can then elect to confirm registration and become a vendor 208 or the vendor can ignore the confirmation request and the account will remain in a pending status 210 for a predetermined period before being deleted from the system 100. In alternate embodiments, any known and/or convenient vendor registration system can be used with can include requiring a vendor to provide specific information and or provide access to additional vendor data.

Once a vendor account is established 208, the vendor can access the system 100 via a login portal 212. In the embodiment depicted in FIG. 2, the vendor portal is comprised of two primary areas: Search/advertising categorization area 214 and a vending area 216. In the embodiment depicted in FIG. 2, the search/advertising categorization area allows a vendor to input information related to the goods/services offered by the vendor and provide information regarding special offers, events, promotion and/or other items of interest. These items can be categorized 218 by the either the vendor and/or the system. The categorization can include both a primary category, such as clothing and at least one sub-category, such as women's clothing. The categorization and items of interest can then be indexed and stored 220 by the system 100 in the database 112. The indexing and categorization allows a user to search more effectively using hierarchical searching techniques which can restrict searches to either items of interest to a user, items of interest with a user's geographic area, based on information contained in a user's information management system, based on a user's predefined preferences, based on events indicated in a user's calendar and/or to-do list, and/or based on any selected predetermined criteria.

In the embodiment depicted in FIG. 2, the vending area 216 can allow a vendor to generate, upload, post, provide a link to or otherwise reference a vendor's website. In the embodiment shown in FIG. 2, step 222 allows a vendor to generate a customized website with coupons 222 for use within the system 100. However, in alternate embodiments, the hosted website can be generated by the system 100, based on content from the vendor's primary website and/or can provide as little and/or as much information as the vendor selects. In some embodiments, the website can include user ratings and comments and/or any other form of review.

In the embodiment depicted in FIG. 2, the database 112 can be indexed, classified and cross-referenced in step 220 to provide customized search results and or advertisements 224 for a user based on any of the user's data and/or user account information and a user can be presented with ads either in real time by a specific user-generated search or at specified intervals either based on a specific user-generated search and/or anticipated searched based on indexing, parsing and review of the information contained within the user's account information and/of the user's data. Such indexing parsing and review of the user's information can be conducted by an automated review system, can be preformed manually and/or via a combination of manual and automated techniques. In some embodiments, the user can be provided with a link to the system-hosted vendor website coupled with reviews of the website and/or system information regarding the vendor and a link to a third-party website.

In some embodiments, the database 112 can be linked with the vendor's good/services inventory system to allow real-time determination of inventory levels and availability of particular goods/services.

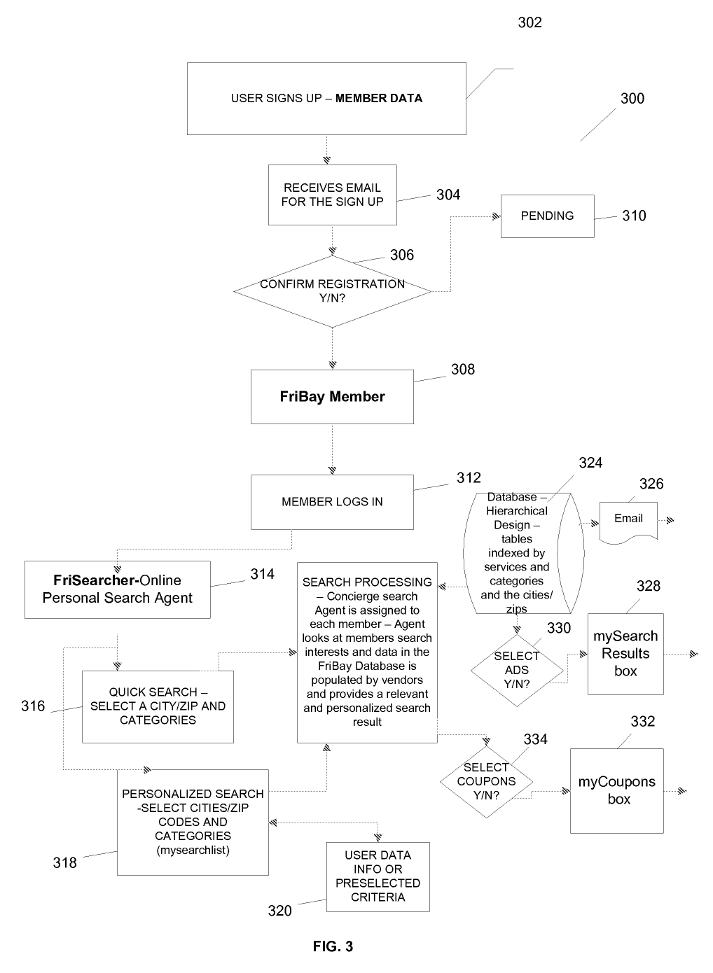

FIG. 3 depicts an embodiment of a user access point 300. In the embodiment depicted in FIG. 3, a user can provide user data 302 which can be conveyed to the system 100. The system 100 can then generate a confirmation 304 in the form of an e-mail or any other know and/or convenient form. In step 306, the user can then elect to confirm registration and become a user 308 or the user can ignore the confirmation request and the account will remain in a pending status 310 for a predetermined period before being deleted from the system 100. In alternate embodiments, any known and/or convenient user registration system can be used with can include requiring a user to provide specific information and or provide access to additional user data, such as a link to a personal information management system or the like.

Once a user account is established 308, the user can access the system 100 via a login portal 312. In the embodiment depicted in FIG. 2, the vendor portal is comprised of a primary search area 314. The user can construct search queries based on classical geographic searching based on Zip codes and/or city, state information 316 or can conduct searching based on specialized search criteria 318 which can be provided by the user and/or determined by the system 100 based on the user's information and data 320.

In step 322, a search engine, either in an automated manner and/or with manual interaction, can perform a search of the system's information database 324 and provide a user with search results meeting the search criteria. The user can then be presented with a variety of information depending on the user's desired results. In some embodiments, the user can be presented with results via e-mail 326, or can be presented with a search results directly 328. In alternate embodiments, the search results can be presented in abbreviated form and/or an advertisement can be presented and a user can be prompted to accept the abbreviated results and/or advertisement 330. In some embodiments, the user can be presented with results in the form of a coupon 332 and the user can be prompted to accept or reject the proposed coupon 334.

In some embodiments, the process of steps 312-332 can be implemented in a fully and/or partially automated manner in which the system 100 performs searches and presents results based on information contained in the either the user's information and/or data and/or based on data received from a user's personal information management system and/or based on previous searches and/or based on user preferences and/or based on events contained in a user's calendar and/or to-do list.

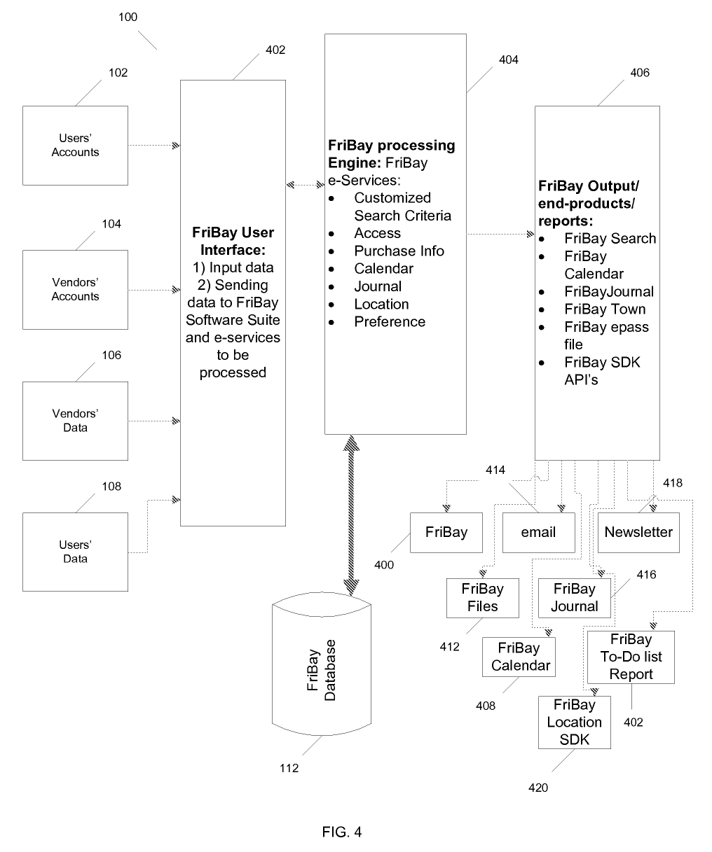

FIG. 4 depicts an embodiment of a high level schematic of an integrated calendaring and concierge service 100. The embodiment shown in FIG. 4 is comprised of a user account module 102, a vendor account module 104, a vendor data module 106 and a user account module 108. In the embodiment shown in FIG. 4, the data collected from the modules 102-108 can be delivered to an interface 402. The interface 402 can then interact with a database 112 via a processing engine 404 and produce output/results 406 in various forms and delivery such information to a user.

In the embodiment depicted in FIG. 4, the user account module 102 can include registration information and data of any type and/or kind desired. In some embodiments the user account module can include name, address, gender, marital status, familial information, display preferences, user name, password, account type and/or any other known and/or convenient information. Similarly, the vendor account module 104 can include registration information and data of any type and/or kind desired. In some embodiments the vendor account module can include name, address(es), display preferences, vendor size, number of locations, user name, password and/or any other known and/or convenient information.

In the embodiment depicted in FIG. 4, the vendor data 106 module can include any known and/or convenient data related to the vendor's account and any known and/or convenient data regarding the vendor's items and/or services for sale, such as item name, available quantities, available sizes and quantities available of given sizes, shipping times, local availability at various vendor locations, Universal Product Code (UPC) information, product and/or service description and/or images, Stock Keeping Unit(s) (SKU) information, pricing information, item number information, promotional and/or event information and/or any other know and/or convenient data related to the vendor's inventory of goods and/or services. In some embodiments this information can be entered directly into the system 100. However, in alternate embodiments the data can be retrieved from existing data stored on another system via any known and/or convenient transfer protocol and/or mechanism. In some embodiments, the data can be transferred and/or synchronized via “push” technology and/or periodic synchronization with a vendor's database. Additionally, in some embodiments, the system can prompt a vendor to input data and/or the desired data can be obtained from the vendor's database on an as-needed basis via any know and/or convenient system and/or method.

In some embodiments, the user data module 108 can contain information any known and/or convenient data related to the users account and any known and/or convenient data regarding the user's preferences, such as size information for the user and/or any other person and/or entity, various shipping/delivery addresses for the user and/or any other person and/or entity, preferred stores and/or service providers, seating preferences, event preferences, cuisine preferences, calendar/schedule information, special event information related to the user and/or any other desired person and/or entity, to-do listings for the user and/or any other person and/or entity, travel information related to the user and/or any other person and/or entity, and/or preference information regarding and/or any other known and/or convenient data related to the user and/or any third party. In some embodiments this information can be entered directly into the system 100. However, in alternate embodiments the data can be retrieved from existing data stored on another system via any known and/or convenient transfer protocol and/or mechanism. In some embodiments, the data can be transferred and/or synchronized via “push” technology and/or periodic synchronization with a user's handled device and/or other personal data management system. Additionally, in some embodiments, the system can prompt a user to input data and/or can allow free-form entry of data which can later be parsed.

In the embodiment depicted in FIG. 4, the interface 406 can receive all and/or selected portions of the user account module 102 data, vendor account module 104 data, vendor data 106 data and user data 108 and/or can link to user and/or vendor external systems to obtain information and data. Such external link can be made via any know and/or convenient method and/or mechanism. In step 404, the processing engine 404 can access the database 112 and the all and/or selected user and vendor information and data and perform searching, cross-referencing and indexing functions to determine matches between user account module 104 data, user data 108 and vendor account module 104 and vendor data 106. In some embodiments, the user account module 102 data, vendor account module 104 data, vendor data 106 data and user data 108 can be stored on the secondary database 112 and/or can be referenced on the secondary database 112. In some embodiments, the user information can be imported, parse and indexed into various modules with the system 100, such as an access information, customized searching criteria, purchase information, system calendar, system journal, location information, preference information and/or any other known and/or convenient categorizations.

In some embodiments, the system 100 can produce output 406 to a user and/or a vendor regarding a match. In some embodiments, the report can be produced periodically according to vendor, user and/or any predetermined schedule and/or can be produced on an as-available basis. Such output can include a system calendar 408, search results 410, raw and/or formatted data files 412, e-mail 414, journal files 416, newsletters 418, location specific data and information 420, a to-do list 422 and/or any other know and/or convenient output data in any known and/or convenient form and/or format.

In operation, a user may have a defined event in a user's calendar such as “trip to London.” The user data may contain various dates and/or airlines and flight times, such as British Airways and afternoon flight. The system can then index, cross-reference and search this information relative to the various Vendor's data and obtain a match for a local carrier with flights available on the specific dates at the preferred times. The system could then return the information to the user or present the user with a link to either the website and/or contact information for the carrier. In some embodiments, the system 100 could directly interact with the vendor either manually or via electronic communication and purchase the ticket from the carrier or reserve the ticket for the user or purchase the item from a website (using the user's banking and/or credit card information) The system can also be used to arrange for purchase, availability, delivery, viewing and/or booking for any other goods and/or services offered by any vendor—such as retail purchases and/or dinner reservations.

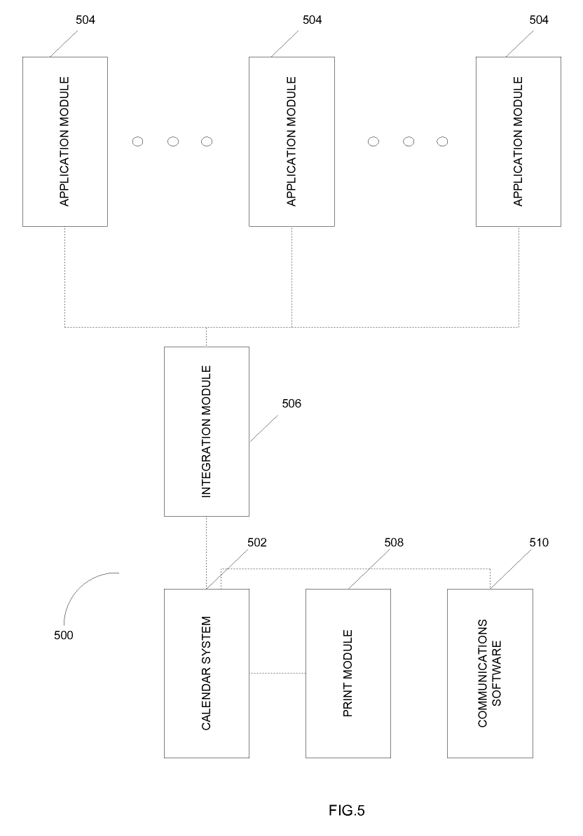

FIG. 5 depicts a calendaring system comprising a temporally based system which enables a user to schedule and track various activities by incorporating third party data related to the activities into a calendar system for the activity scheduling function. In one embodiment of the system 100 disclosed herein, the calendaring system is shown as a combination of hardware and software which are cooperatively operative to provide the user with information which the user requires to identify and efficiently schedule various activities that are of interest to the user. The various elements shown in FIG. 5 represent but one technological implementation of this system and are used to illustrate the concepts rather than to limit in any way the scope of the claimed invention. The calendaring system as seen by the user comprises a display device and a data input device, such as a keyboard and/or mouse, which are connected to a user terminal device. The user terminal device is equipped with a central processing unit and memory, typically including a hard disk drive, on which the software is resident. This system may optionally be equipped with a printer device and/or a modem which enable the user to output information in paper form and to input/output data in electronic form, respectively.

The calendaring apparatus 500 is shown in block diagram form in FIG. 5 and comprises a calendar system 502 which interconnects with the clock C of the central processing unit CPU to generate and maintain the calendars described below. The calendar system 502 preferably comprises a module which dynamically generates a present date calendar, which date is indicated by the system clock C, and presents a display to the user on display D of this present date calendar in the form selected by the user. In addition, at least one, and preferably a plurality of application modules 504 (also termed time based software modules hereinbelow) are included, each of which generates data indicative of events which may be of interest to the user. The events can be time-based or situational-based and, for the purpose of illustration, the time-based applications are described herein. One or more of these application software modules 504 can reside external to the user terminal device PC, such as on an Internet site as noted above. For the purpose of this description, the application software modules 504 are described as resident in the user terminal device PC. An integration module 506 is also provided which functions to receive selected application data produced by the application software modules 504 and integrate this selected data into the calendar produced by the calendar system 502. Optionally, communication software 510 is included to utilize the MODEM device MC to interconnect this system with other processors. A print module 508 is also optionally included and comprises printer drive software which operates with the printer interface Pi in well known manner to activate a printer connected to this system. In any case, the system integrates third party information into the calendar system to enhance the functionality of the calendar system. Much of the third party data is time-based and lends itself to the calendar function, but this data can include any application data, such as situational-based data, news information, E-Mail data, and the like.

The integration module 506 functions as a database, which stores data in memory M for retrieval on an organized basis for the calendar system 502 for presentation to the user via display D. In particular, the integration module 506 responds to user input from the calendar system 502, in the form of data input via the display screens described below, to identify which of the application modules 504-504 contain the requested data (such as module 504). The integration module 506 excerpts the requested data from the selected application module 504 and transmits this data to the user via the appropriate screen displays. The user selected function can result in the retention of the excerpted data in the calendar system 502, especially in the case where the application module 504 represents third party data which is resident in a processor system external to the user terminal device PC (such as a MODEM connected Internet server). Alternatively, the data excerpted represents transient information, to be displayed to the user and then discarded once the user selected function has been exited. The specific applications of this function are evident from the following description of the various functions implemented in the calendaring system 500. It is expected that the implementation of the integration module 506 is in the embodiment of a database, although any other comparable data processing system can be used in place of the database or in conjunction with the database to implement the functions described below. Thus, data filters, user preference monitoring systems, geographic location determination systems, query systems, graphic display generation systems, and the like can be incorporated into the integration module 506 as a function of the level of sophistication the software designer wishes to achieve. These systems are presently available and well within the scope of ability of one skilled in the art to combine with a database to implement the functions described below.

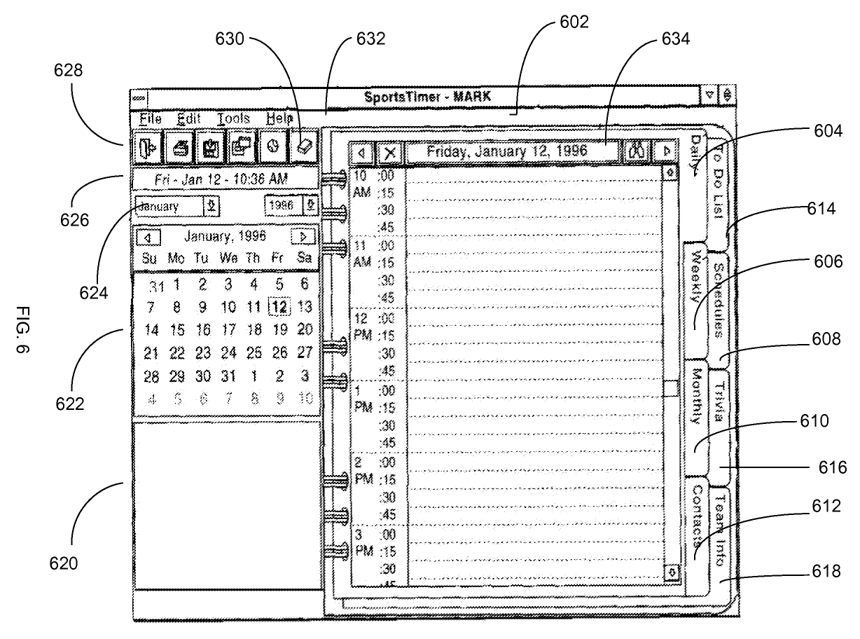

The user of the calendaring system 500 can have a preference as to the mode of presentation of the calendar data produced on the display D. Since this preference or the user's needs can vary, a plurality of calendar display modes are possible. To simplify the user's choice, the basic format of the calendar presentation illustrated as one embodiment is shown in FIG. 6 as appointment book, open to a particular page 500 representative of the present day, and having a plurality of tabs 604-618 which represent the various major selections available to the user. The number of tabs is a function of the hierarchical architecture and number of functions implemented in the system. Eight tabs are shown here for simplicity of illustration.

The presently active tab 604 shown in FIG. 6 is “Daily” which results in the calendar system 502 presenting an appointment book presentation of time entries. It should be noted that to produce a display of clarity and extent that is efficient, the times indicated begin with the hour that matches the present clock time. Thus, the present date 502 is displayed at the top of the appointment book page 500, which date and the present time is also displayed to the left of the appointment book page 500 in field 626. As can be seen from the time shown therein, it is 10:36 AM and the appointment book therefore begins its appointment book page 602 display at 10 AM, the present time (on an hourly basis). The appointment book page 602 display presents a plurality of hourly slots for entries (six being shown in FIG. 6), and time slots preceding and following those displayed can be accessed by the user activating the up and down arrow icons displayed on the right hand side of the page, in well known fashion, to view other time periods for this date. In addition, a pair of arrow icons are provided adjacent the displayed date filed 626 to enable the user to switch the appointment book page 602 display to earlier or later dates to view the same format display for those selected dates. Furthermore, as the hour changes, the calendaring system 500 can scroll the screen display to reflect the time change. Thus, appointment book page 602 can always maintain the present time as the top-most entry on the display.

A monthly calendar 622 is also shown to the left of the appointment book page 602 display to enable the user to have ready access to information regarding the remainder of the month. The selection fields (624, 630) located above the displayed monthly calendar 622 enable the user to change the presented month 624 and year 630 by activating the scroll icons located adjacent to these entries. Furthermore, a menu MU is presented on the top of the screen to enable the user to access “Help”, “Tools”, “Edit” or “File” options as is commonly found in computer programs. The tab options T* displayed on the right hand side of the appointment book page 602 are also replicated in icon form 628 below the menu bar 632. A field 620 is optionally provided, shown in the lower left hand corner of the display, for display of a logo, typically indicative of the manufacturer or distributor of this calendaring system, or any advertiser who wishes to present their commercial information, as described below. This field 620 can optionally be used to display messages or other information to the user.

In order to simplify the following Figures, the specific references to the elements illustrated in FIG. 6 are not repeated in these figures, except where believed useful for an understanding of the description of these figures.

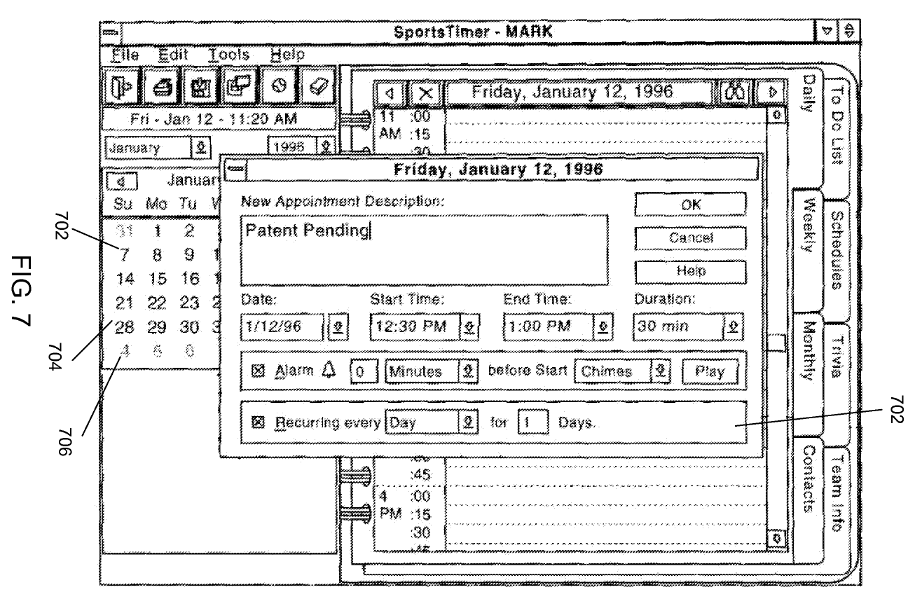

FIG. 7 illustrates a screen display which is presented to the user when the “edit” option is selected from the menu bar 632 and the “new” (not shown) submenu entry is selected. Alternatively, the edit function can be activated by clicking on the icon or double clicking on the listed event. This display comprises an edit window 708 overlaid on the basic appointment book page 602 display of FIG. 6. The edit window 708 enables the user to manually enter event information into the calendar system 502. In particular, a description field 702 is provided to enable the user, using keyboard K, to type in a textual notation for display on the appointment book page 602 of the calendar system 502 for the date and time selected via the input fields 704 located below the textual entry field 702. In addition, an alarm menu 706 is provided to enable the user to turn on the alarm function by selecting (“X”) “Alarm” and setting the length of time prior to this scheduled event the alarm should be generated. The user can also select the type of alarm indication, from a menu of possible visual and audible alerts that can be produced by the user terminal device PC. An event repeat function is available to enable the entered event to be presented a plurality of times, such as a weekly meeting at a predetermined time. The repeat function eliminates the need for the user to seriatim enter the same information on successive dates. Once the user is satisfied with the new appointment entry input via the edit window 708, it is entered into the calendar system 502 by operation of the “OK” icon.

In operation, the data and information contained in the described system can be either imported into the system 100 or can be implemented on a user's system and the information and data can be transmitted/synchronized to the system 100 either periodically, via a “push” mechanism and/or accessed on an as-needed basis.

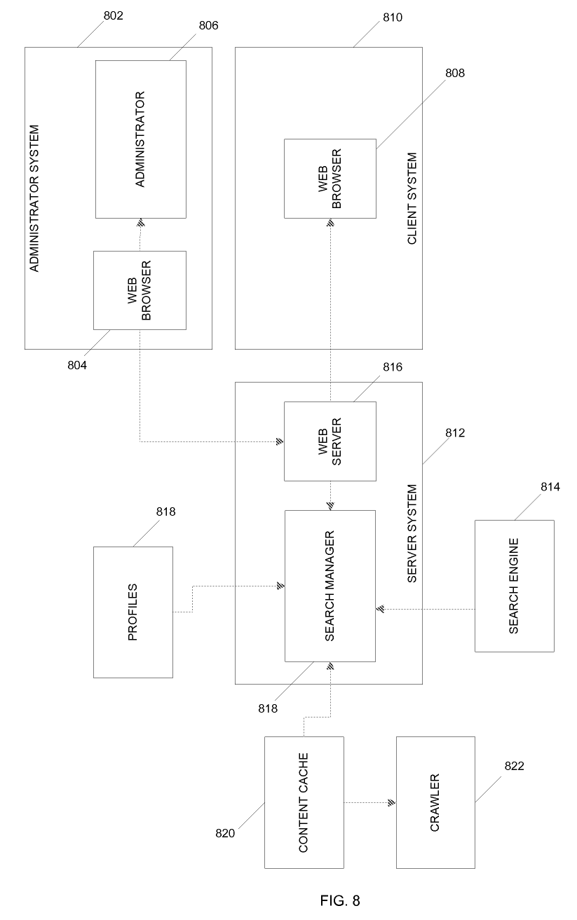

FIG. 8 shows a system in accordance with the present disclosure capable of conducting a categorized search. An administration system 802 includes an administrator application 806 and web browser 804. The administrator 802 may communicate via web server 816 to the server 812. The administrator system 802 may be employed to configure a content category taxonomy for the search manager 818. The administrator system 802 may be further employed to configure a mapping of content categories to domains. In one embodiment, the taxonomy and mappings may be stored by the server 812. Of course, the taxonomy and mapping could also be stored elsewhere, including in a fashion distributed among servers of the network. For example, each available search engine could store its own content categories and associated mapping of content categories to domains, which might then be merged to produce a complete taxonomy.

The administrator 802 may also be employed to associate access policies with search engines and/or search domains. For example, some search domains may require an authentication procedure, or certain payment terms, before allowing a search to proceed. Further, the administrator 802 may be employed to define a set of one or more default search engines and/or domains for particular content categories. It may be possible for a user, upon submitting a query, to override these defaults by explicitly specifying a set of search engines and/or domains. The administrator 802 may also be employed to set policies for the order in which search results should be returned from multiple search engines and/or domains, and how multiple sets of search results should be merged (duplicate elimination, etc.).

The search manager 818 may read user profile information from a profile database 818. Profile information for a user may comprise information about prior searches submitted by the user, as well as a user's preferences. Using the profile information, the search manager 818 may instruct the search engine 814 to update the results of the user's prior searches. The updated results of the user's prior searches may be stored in the content cache 820. The user may access these results, which may then reflect more recently available information. A web crawler 822 may be employed to direct the updating of prior search results on a periodic basis.

The user profile information may also be provided to search engines so that when a search query is received from a particular user, the search engines may determine how many search results to return, how to interpret various search terms, and so on. In alternate embodiments various other search methods can be employed to conduct a categorized search.

In some embodiments the categorization tool can identify key terms identified by the system 100 and/or defined by the user and/or vendor.

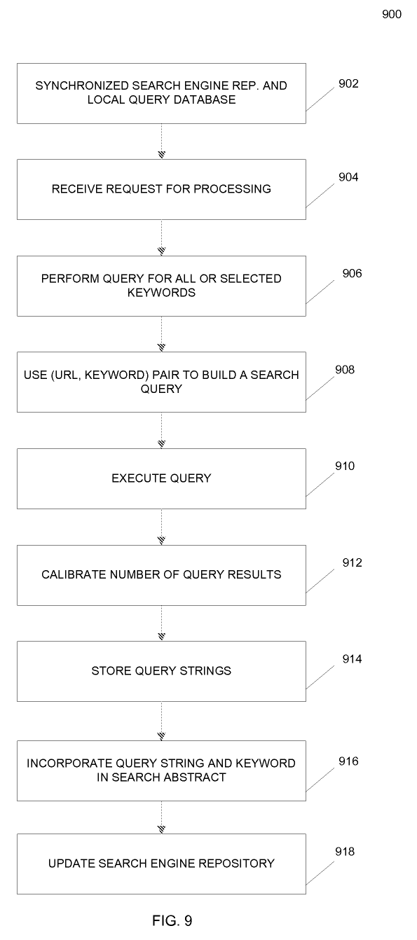

FIG. 9 depicts a flow chart of a filtering search engine which can be enabled within the system 100.

With reference to FIG. 9, the abstract keywords association system generally includes a query builder, a search result calibration manager, a summary marker, a synchronization unit, a search result Item buffer, and a keyword detector. The method of operation 900 of the abstract keywords association system that can be embodied in the system 100 is described herewith.

As depicted in step 902, the synchronization unit synchronizes the content of a search engine repository and a local query database, as the search engine repository is typically very dynamic, and new resources are periodically added, removed, and updated. Preferably, the direction of the synchronization is from the local query database 112 to the search engine repository. The abstract keywords association system reacts to changes and updates of the search engine repository, but the local query database 112 will not trigger changes.

Initially, the synchronization unit loops through all the summary data, and extracts the URLs along with the summary data. Then, it conveys this information to the search result item buffer for further processing. Subsequently, the synchronization unit will respond to notifications from the search engine.

With reference to step 904, the keyword detector receives a request for processing a summary metadata item from the search result item buffer. The keyword detector loops through the text in the abstract, and creates a list of keywords that are included in (i.e., members of) the domain-specific dictionary. Essentially, and as shown in step 906, a query can be performed for each keyword in the dictionary. However, the performance of the system 100 could be improved if frequently used keywords are cached. In addition, noise words noise words could be minimized prior to performing the query.

The system 100 can follow one of two approaches to generate query strings for the keywords in the dictionary: an exhaustive approach, or an expedient approach. In the exhaustive approach, the system 10 considers each keyword in the dictionary, and generates a search link for each member keyword of the dictionary. As a result, for each keyword, the keyword detector creates a (URL, keyword) pair for each of the keywords, which will be stored in the local query database 112, and forwarded to the query builder, in order to construct a query string. The term “URL” is used herein to connote an address or location.

During a search session, when the keyword detector detects a keyword (i.e., XOX) in the abstract, the local query database 112 is queried for that particular keyword (i.e., XOX), that is the supplemental search query for this keyword is executed to retrieve the corresponding query string from the local query database. This exhaustive approach does not require that a calibration process be performed.

The expedient approach differs from the exhaustive approach in that the system 100 does not generate a query string for each member key word of the dictionary. Rather, the query strings are generated on demand. During the query building process, when the keyword detector detects a keyword in the abstract, the search engine checks if the desired query string has already been and stored in the local query database 112. If it has, then the associated query string is retrieved. If it has not, then the system 100 generates a query string for the keyword, and stores the query string in the local query database 112.

The query builder uses the (URL, keyword) pair, and builds a search query from a query template using the search engine repository in step 908. A fully constructed query string is then forwarded to the search result calibration manager for processing.

An initial version of the query string is first built using a single keyword, and attaching this keyword in the query template. Each keyword in the domain-specific dictionary has a list of synonyms, and also a list of related words. After passing a query request to the search result calibration manager, which, in turn, evaluates the search query, it is possible to obtain an acceptably high number of search result items in the search result set. In this situation, the query builder receives a request from the search result calibration manager to modify the query string as follows:

1. If too many hits are generated, the query builder adds restrictions to the query string and/or chooses different synonyms.

2. If insufficient hits are obtained, the query builder removes certain restrictions from the query string and/or chooses different synonyms.

3. If the query search is not acceptable, the query builder can issue a request to choose a different search service provider 100, which entails the use of a different query template and repeating the process of building a query.

The query builder is mainly concerned with the generation of the query string which is based on a query template. The search result calibration manager cooperates with the query builder for sending query modification requests, in order to optimize the query.

The search result calibration manager receives a fully constructed query string from the query builder and performs the actual query at step 910. The search result calibration manager then calibrates the number of query results at step 912. The search result calibration manager receives the query results, and then determines the number of the search result items, pursuant to a scheme description from the search engine provider. If the number of hits is excessive, the entire query string is automatically returned to the query builder along with a request to refine the query. If the number of hits is too low, the entire query string also is automatically returned to the query builder along with a request to broaden the search query. The specific upper and lower limits for the number of hits can be set by the user.

The process of calibration is repeated until the number of search result items or hits is preferably within an acceptable range (i.e., within the upper and lower limits). In addition, there are timeouts and network constraints to consider. For instance a search service provider could fail to provide results. In which case the query string will be returned to the query builder to select a different search service provider.

When the optimal query string is computed, it is stored in the local query database, at step 914. Also, a request to the summary marker is forwarded along with the query string, to incorporate the final query string with the keyword in the abstract of the search result item, at step 916.

At this stage, an optimal query string has been computed from the search result calibration manager, and stored in the local query database using the URL and the keywords as the primary index keywords for subsequent retrieval. One feature of the present disclosure is to update the search engine repository at step 918, to reflect the changes in the abstracts.

In some embodiments, a separate search engine provider database can be used to supplement the local query database 112. The search engine provider database would contain all the available search service providers are stored, along with corresponding schemes on how to query these search service providers. The search engine provider database might need to be maintained manually.

In some embodiments, the primary search can be conducted in the above-described manner and then filtered based on the user preferences and account information and user data (including geographic limitations). Alternately, assigned categories and sub-categories can be used to filter and search data and provide results.

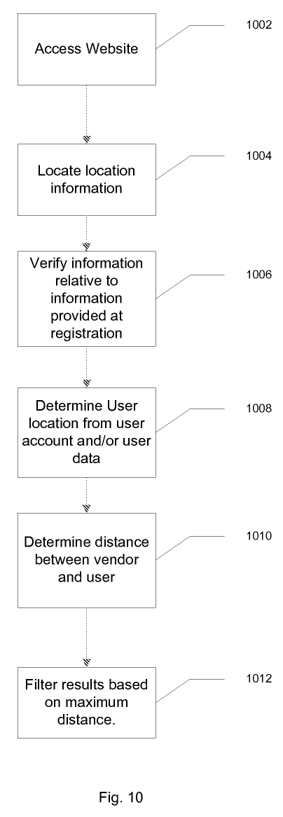

FIG. 10 depicts a flow chart for determining location of a “brick and mortar” location associated with a website and a method for filtering search results based on such a determination.

In step 1002, the vendor's website is access and in step 1004 information regarding the location of physical “brick and mortar” stores is located on the website. Various methods to determine physical location of stores exists and any known and/or convenient method and/or system can be used to determine such information. In step 1006, the obtained information is evaluated relative to the vendor information provided at registration and in the vendor data. In step 1008, the user data is probed to determine a geographic location for the user. Then in step 1010, the distance between the physical location of the user and the physical location of the vendor's stores is calculated. In step 1012, a filter can be applied to determine if any one of the vendor's stores is located within a prescribed distance from the user. If any store is proximally located, the vendor's store may be included in search results and/or used for further searching in accordance with the system 100. If the vendor's stores are not proximally located, then the vendor can optionally be excluded from the results and/or further searching in accordance with the system 100.

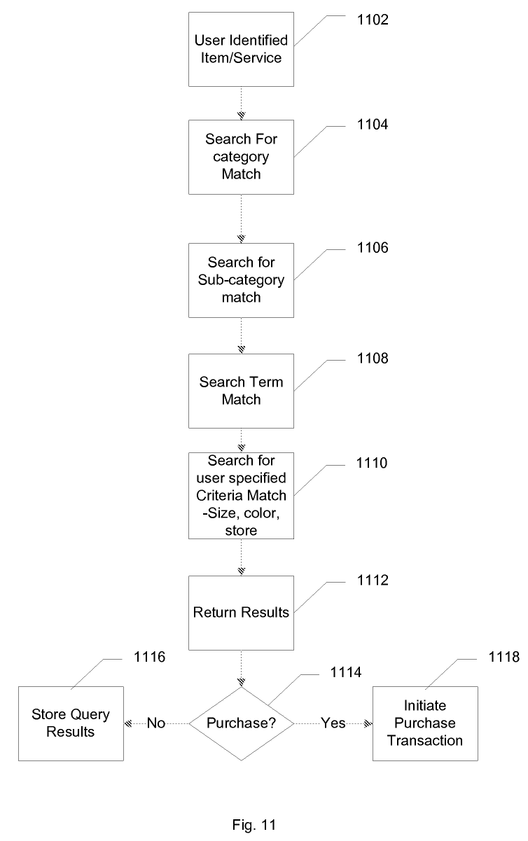

FIG. 11 depicts a search method based on categorization and user preferences. In step 1102, the user identifies a desired good/service and the parameters surrounding the purchase of the desired good/service. In some embodiments the user identified goods/services and associated parameters can be obtained directly from any of the user data and/or user account information, such as an item from a to-do list cross-indexed with preferences from a user's journal.

In step 1104, the search can be parsed for categorization terms and an initial search can be conducted based on the primary categorization. In step 1106, the search can be parsed again for sub-categorization terms and an secondary search/filter operation can be run on the search results obtained from the primary search. A tertiary search/filter can then be run 1108 on the resulting data to determine which results match search terms that are not category or sub-category definitive. The resulting websites from this search can then be further probed 1110 to determine if criteria matches can be found and the results can be returned to the user 1112. Any known and or convenient method and/or mechanism can be used to probe the websites to determine if criteria matches are available. After a user is presented with results, the user can elect 1114 to either store the results 1116 for future consideration and/or proceed with a purchase 1118.

In some embodiments the decision to proceed may be bypassed and, if a certain predefined level of matching is achieved, a purchase transaction can be immediately implemented.

In operation, if a user has a scheduled event in his calendar such as “dinner meeting with client,” the system 100 can cross-reference the term dinner and the user's preferences for dining facilities. The system can then conduct a search based on the user's preferences and present the user with a list of restaurants matching the user's dining preferences and allow the user to directly make reservations at a selected dining facility without directly interacting with the dining facilities website—the reservations can be made by the system. The system can be configured to make such reservations at a predetermined time before the calendared event so that the user.

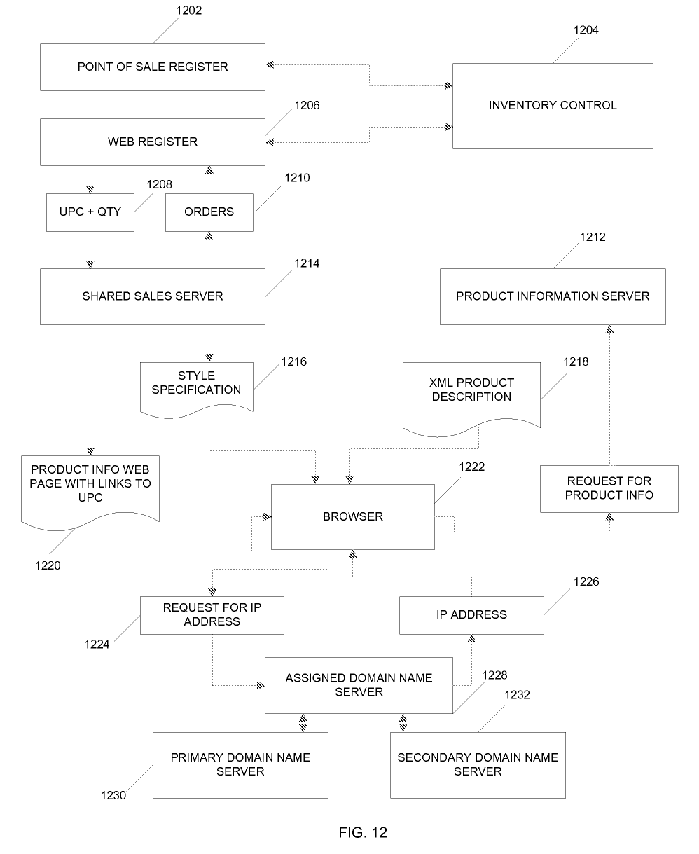

FIG. 12 illustrates a system which permits computers operated by large numbers of manufacturers and large numbers of online retailers to work together to provide shopping services to customers via the World Wide Web, which can be implemented within the system 100.

FIG. 12 shows a browser 1222 being used by an online shopper to view products offered by a retailer which operates an inventory control system computer seen at 1204. The inventory control system 1204 is conventional and includes one or more conventional point of sale registers as illustrated at 1202 through which sales are made to customers who visit the physical “bricks and mortar” store. In addition, however, the inventory control system is provided with a “web register” which appears to the inventory control system to function in the same way as a conventional point of sale register but which, in fact, operates through a sales server 1214 which provides Internet services on a shared basis to multiple retail stores and their inventory control systems. A communications pathway connects the web register 1206 and the inventory control system 1204 to the shared sales server 1214, with the inventory control system 1206 supplying the product codes and corresponding on-hand quantities as indicated at 1208 and receiving from the shared sales server order information as indicated at 1210.

A product information server 1212 supplies product information to the browser 1222 in the form of XML data as indicated at 1218 in response to requests 425. The browser 1222 preferably utilizes the Internet domain name system as proposed above to convert incoming universal product codes into Internet addresses, with the domain name system consisting of an assigned domain name server 1228 which receives domain names containing universal product codes in address requests 1224 and returns the registered Internet addresses 1226 to the browser 1222. When needed, the assigned domain name server 1228 obtains the registered cross-references between domain names containing universal product codes and IP addresses from the primary DNS 1230 or from the secondary DNS 1232.

The shared sales server 1214 sends web pages 1220 containing information about products available from a connected retailer to the browser 1222, along with XSL (Extensible Stylesheet Language) or CSS (Cascaded Style Sheets) style specifications as seen at 1216. The use of XML and XSL or CSS provides several advantages. First, the selection and rendering of the product information is controlled by the links specified in the web page 1220 as produced by the sales server. For example, if the web page 1220 contains a product listing web page created in response to a search request from the browser 1222, each included product description may include a link to only an that portion of an XML product description which contains a brief product description and a thumbnail image of the listed product, whereas, in response to a customer's request for more detailed information, the sales server may return a web page containing an XML “Xpointer” link to detailed product information and/or to an enlarged image of the product. In both cases, the style in which the XML data is rendered by the browser (e.g. typeface, font size and color, background color, etc.) is controlled by the style specification supplied by the sale server. In this way, the same XML data may have different visual styles when included on the pages created by different retail vendors.

The XSL (Extensible Stylesheet Language) consists of consists of two parts: (1) a language for transforming XML documents, and an XML vocabulary for specifying formatting semantics. An XSL stylesheet specifies the presentation of a class of XML documents by describing how an instance of the class is transformed into an XML document that uses the formatting vocabulary. An XSL stylesheet processor accepts a document or data in XML and an XSL stylesheet and produces the presentation of that XML source content as intended by the stylesheet. It is contemplated that most major web browser applications will include XSL stylesheet processors which will enable them to convert the combination of XML and XSL data into a form, such as a viewable HTML web page, as specified by the XSL.

In addition to using XSL to specify the rendering style of XML data, cascaded style sheets (CSS) can also be used with any other known and/or convenient system can be used.

The manner in which explicit relationships between two or more data objects, such as a retailer's product list page and the product information about a product listed on that page, may be expressed as a link asserted in elements contained in XML documents. These “XLinks” is the simplest case are like the HTML links described above in that they are expressed at one end of the link only, are initiated by users to initiate travel to the other end of the link, go only to one destination (which may be determined by a DNS server or by an independent cross-referencing server), and produce an effect which is mainly determined by the browser. As extended, the XLink specification provides more sophisticated multi-ended and typed links which can be used to advantage to automatically incorporate linked-in product information from one or more manufacturers into displays and multimedia presentations presented by retailers and others.

As previously discussed, in addition to the use of a product code translation utility which cross-references all or part of a universal product code into an Internet address, it is desirable to establish a protocol or convention which enables a requester to specific kinds of information about identified products or companies. In a conventional HTML system, this can be done by establishing naming conventions, as described above, for selectively locating different kinds of information about a product designated by a given universal product code, as well as different kinds of information about the company identified by the company code portion of the product code.

The metadata capabilities of XML can be used to advantage to provide an extensible system for dividing product and company information into a hierarchy of nested named elements which can be selectively accessed. Using the Document Type Descriptor (DTD) component of XML, the makeup of the required and optional components of such information can be defined in a standard way, facilitating the definition and validation of data structures to be used on various classes of products.

RDF provides a mechanism for defining metadata in a class system much like the class systems used by object oriented programming and modeling systems. Classes are organized in a hierarchy, with a collection of classes used for a particular purpose (such as the collection of classes describing a “product” and/or the collection of classes describing a “company”) being called a “schema.” RDF thus offers extensibility through subclass definition. For example, creating subclasses for a particular kinds of product (e.g., publications, software, foods, clothing, etc.) requires only incremental modification of a base “product” schema, and each such subclass may then be further modified to form descendant schema for even more particular kinds of product (e.g., magazines, video games, cereals, shirts, etc.). The shareability and extensibility of RDF also allows metadata authors to use multiple inheritance to mix definitions, providing multiple views of their data, and leveraging the work done by others. From a practical standpoint, the creation of a simple and generic product and company description base schemes which can thereafter be extending using RDF allows basic information about products and companies to be made available early, allowing more elaborate schemes to evolve as experience with the simpler system suggests their utility.

Using these techniques, the product manufacturer may be largely freed from concerns about web page design, formatting and integration with other information, and may concentrate on providing accurate and up-to-date text descriptions of its products, along with whatever images best describe the product, simply by registering the relationship between the manufacturers company code and/or universal product code(s) with the appropriate authority, and following the established content specifications for the information which the manufacturer makes available at the host specified by the registered product code or company code domain name.

It should be noted that XML, XSL, Xpointer, XLink and related Internet protocols and specifications are still being defined and extended, a process that can be expected to enhance the ability of the present system 100 to selectively and attractively provide information about products to those who desire that information from the most knowledgeable and reliable sources of that information.

Conventional retail stores display merchandise for purchase in physical showrooms for inspection and purchase by consumers. These stores typically obtain the products they sell from a large number of manufacturers, either directly or through distributors. Computerized inventory control systems are used to keep track of orders and sales in an effort to insure that goods are available for prompt delivery to customers when purchased while minimizing the expense of the maintaining an unsold inventory of products. Barcode checkout and EDI (Electronic Data Interchange) systems are commonly used in combination with inventory control systems to automate sales transactions. Customer checkout counters equipped with barcode readers automate the customer sales transaction, reducing errors and reducing costs. EDI, the computer-to-computer exchange of business documents in a standard format, automates transactions between the retailer and its suppliers by transferring sales documentation in electronic form, including the purchase order, the invoice, and the advance ship notice. Barcode readers and EDI services are now commonly used even by smaller retailers and have significantly reduced the cost of doing business.

In recent years, the Internet has produced new on-line sales mechanisms which promise to revolutionize retail sales. Using the World Wide Web, both manufacturers and resellers offer products to consumers for direct purchase with product delivery normally being accomplished by mail or a commercial delivery service. The consumer typically employs a web browser to search for products of interest and display product descriptions. Customers make purchases by completing one or more displayed forms to provide needed information (e.g. a credit card number and a shipping destination address). Such inventory determination and processing methods and mechanisms and/or any other know and/or convenient processing mechanism can be employed by the system 100 to determine if items are available and to make purchases.

The shared sales server 1214 operates in the same way and provides the same functions as a conventional online merchant server: it enables customers to perform searches of available products and produces listings which the customer can review, with the ability to click on individual items to activate links to additional product information from the manufacturer's server as noted earlier. In addition, the shared server provides “shopping basket” and credit card transaction services to enable the customer to complete purchases.

The shared server 1214 and the web register module 1206 added to the retailer's existing inventory control system 322 maintain a connection via the Internet or a dial-up MODEM pathway which permits the inventory control system 1204 to upload to the shared server 1214 changes to the products (specified by universal product code) being offered for sale, and the quantity on hand. Each time any sale is made by any point of sale register 1202 in the physical retail store or by the web register 1204, the quantity on hand value associated with the sold product's code is altered. Similarly, when stock is replenished, the inventory control system 1204 reflects the increased quantity on hand. The quantity on hand information passed as message information at 1204 permits the shared sales server to maintain a database for each retailer served which indicates the products available for sale and the quantity on hand. When the quantity on hand equals or exceeds the quantity ordered, the on line order is accepted and passed at 1210 from the shared server to the web register module 1206 which posts the sale in the same way that a point of sale register posts a sale. The fact that the web register 1206 performs the same functions as a conventional cash register enables the conventional inventory control system 1204 to function in the normal way, with the exception that it must also update the product code and quantity on hand data maintained by the shared server. The fact that the shared server thus “knows” the inventory status allows the shared server to accurately inform the customer when shipment can be expected for goods on hand and when goods which must be replenished will be shipped with a delay. Orders sent to the inventory control system at 1210 include the specification of products sold (by their universal product code designation) and the quantities of each sold, as well as address information for billing and shipping. Credit card transactions are handled on a shared basis using standard ecommerce software, either by sending encrypted credit card and other billing information to the retailer for handling, or actually performing the monetary transaction with the customer in its entirety on the shared server, and sending periodic payments and accounting records to the retailer.

In a typical shopping transaction performed on the system shown in FIG. 12, a shopper employs the browser 1222 to visit a web site which executes on the shared sales server 1214. When the shopper reviews an HTML web page which lists available products, as illustrated at 1220 in FIG. 12, the shopper can request additional information on any listed product by using the browser 1222 to click on a link anchor on the page 1220, thereby issuing are request 1224 to the domain name server 1228 for the IP address at which additional information on that product identified by a universal product code which forms part of the URL contained within the request 1224. The DNS 1228, consulting a primary DNS 1230 or secondary DNS 1232 if necessary, returns the IP address to the browser 1222 which then issues a request 480 for XML product information to the product information server 1204 maintained by the manufacturer of that product. Using the XSL stylesheet specification 1216 supplied by the shared server 1214 (in accordance with the background colors, font styles, etc. which may be characteristic for the web presence of the specific retailer), the browser presents the product description contained or specified by the XML data 1218 to the user.

If the user decides to purchase the described product, the “shopping basket” functions of the shared sales server 1214 are used to complete the order. Because the shared server 1214 maintains a database for that retailer containing the quantity on hand values for each product offered by that server, the customer can be immediately informed if the shipment cannot be made whereas, if the product is available at the retailer's store or warehouse, the online customer's order can be confirmed for prompt delivery. When the order is completed by the shared server 1214, the order 1210 which includes the identification of the customer (name, shipping address, etc.) and the identification of the products sold (universal product codes plus quantities sold) is transmitted to the retailer's inventory control system 1206. The shared server 1214 adjusts the quantity on hand values in its database, and the inventory control system 1206 updates its database, with a cross check between the two being made if desired to insure consistency and synchronization.

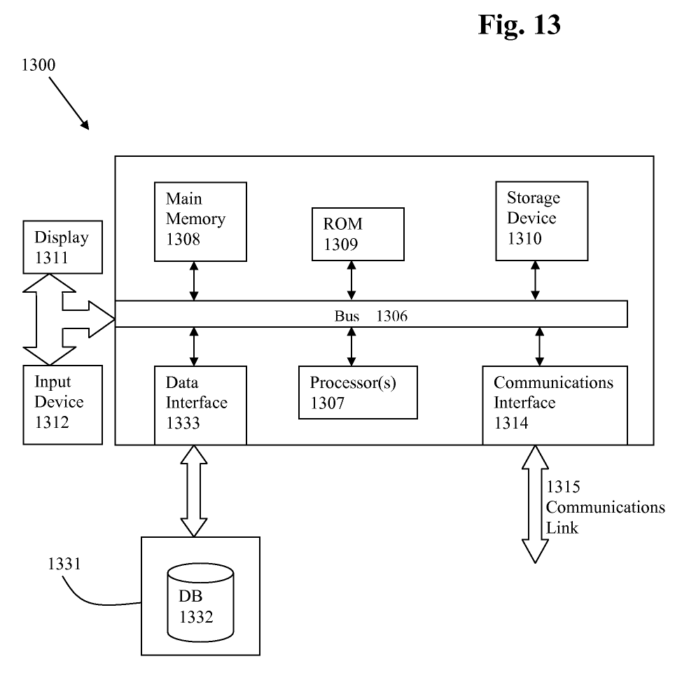

The execution of the sequences of instructions required to practice the embodiments may be performed by a computer system 1300 as shown in FIG. 13. In an embodiment, execution of the sequences of instructions is performed by a single computer system 1300. According to other embodiments, two or more computer systems 1300 coupled by a communication link 1315 may perform the sequence of instructions in coordination with one another. Although a description of only one computer system 1300 will be presented below, however, it should be understood that any number of computer systems 1300 may be employed to practice the embodiments.

A computer system 1300 according to an embodiment will now be described with reference to FIG. 13, which is a block diagram of the functional components of a computer system 1300. As used herein, the term computer system 1300 is broadly used to describe any computing device that can store and independently run one or more programs.

Each computer system 1300 may include a communication interface 1314 coupled to the bus 1306. The communication interface 1314 provides two-way communication between computer systems 1300. The communication interface 1314 of a respective computer system 1300 transmits and receives electrical, electromagnetic or optical signals, that include data streams representing various types of signal information, e.g., instructions, messages and data. A communication link 1315 links one computer system 1300 with another computer system 1300. For example, the communication link 1315 may be a LAN, in which case the communication interface 1314 may be a LAN card, or the communication link 1315 may be a PSTN, in which case the communication interface 1314 may be an integrated services digital network (ISDN) card or a MODEM, or the communication link 1315 may be the Internet, in which case the communication interface 1314 may be a dial-up, cable or wireless MODEM.

A computer system 1300 may transmit and receive messages, data, and instructions, including program, i.e., application, code, through its respective communication link 1315 and communication interface 1314. Received program code may be executed by the respective processor(s) 1307 as it is received, and/or stored in the storage device 1310, or other associated non-volatile media, for later execution.

In an embodiment, the computer system 1300 operates in conjunction with a data storage system 1331, e.g., a data storage system 1331 that contains a database 1332 that is readily accessible by the computer system 1300. The computer system 1300 communicates with the data storage system 1331 through a data interface 1333. A data interface 1333, which is coupled to the bus 1306, transmits and receives electrical, electromagnetic or optical signals, that include data streams representing various types of signal information, e.g., instructions, messages and data. In embodiments, the functions of the data interface 1333 may be performed by the communication interface 1314.

Computer system 1300 includes a bus 1306 or other communication mechanism for communicating instructions, messages and data, collectively, information, and one or more processors 1307 coupled with the bus 1306 for processing information. Computer system 1300 also includes a main memory 1308, such as a random access memory (RAM) or other dynamic storage device, coupled to the bus 1306 for storing dynamic data and instructions to be executed by the processor(s) 1307. The main memory 1308 also may be used for storing temporary data, i.e., variables, or other intermediate information during execution of instructions by the processor(s) 1307.

The computer system 1300 may further include a read only memory (ROM) 1309 or other static storage device coupled to the bus 1306 for storing static data and instructions for the processor(s) 1307. A storage device 1310, such as a magnetic disk or optical disk, may also be provided and coupled to the bus 1306 for storing data and instructions for the processor(s) 1307.

A computer system 1300 may be coupled via the bus 1306 to a display device 1311, such as, but not limited to, a cathode ray tube (CRT), for displaying information to a user. An input device 1312, e.g., alphanumeric and other keys, is coupled to the bus 1306 for communicating information and command selections to the processor(s) 1307.

According to one embodiment, an individual computer system 1300 performs specific operations by their respective processor(s) 1307 executing one or more sequences of one or more instructions contained in the main memory 1308. Such instructions may be read into the main memory 1308 from another computer-usable medium, such as the ROM 1309 or the storage device 1310. Execution of the sequences of instructions contained in the main memory 1308 causes the processor(s) 1307 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 1307. Such a medium may take many forms, including, but not limited to, non-volatile, volatile and transmission media. Non-volatile media, i.e., media that can retain information in the absence of power, includes the ROM 1309, CD ROM, magnetic tape, and magnetic discs. Volatile media, i.e., media that can not retain information in the absence of power, includes the main memory 1308. Transmission media includes coaxial cables, copper wire and fiber optics, including the wires that comprise the bus 1306. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present system 100 may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

Although exemplary embodiments of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed is:

1. A method of providing integrated calendaring and concierge services comprising:
receiving user data;
receiving vendor data;
matching user data with vendor data; and
reporting said matched user data and vendor data.
